(19) United States
(12) Patent Application Publication
(10) Pub. No.: US 2025/0222526 A1
(43) Pub. Date: Jul. 10, 2025

(54) CUTTING TOOL, SYSTEM AND METHOD FOR INCREASING TRACEABILITY OF A CUTTING EDGE

(71) Applicant: SECO TOOLS AB, Fagersta (SE)

(72) Inventors: Micael BAUDIN, Uppsala (SE); Jan GRAVNINGSBRATEN, Angelsberg (SE)

(21) Appl. No.: 19/091,937

(22) Filed: Mar. 27, 2025

Related U.S. Application Data
(62) Division of application No. 17/606,286, filed on Oct. 25, 2021.

(30) Foreign Application Priority Data
Apr. 30, 2019 (EP) 19171911.1

(51) Int. Cl. B23B 27/14; B23B 27/16; B23C 5/20; B23Q 17/09

(52) U.S. Cl. CPC B23B 27/14; B23B 27/16; B23C 5/20; B23Q 17/0995; B23B 2260/104; B23C 2210/66

(57) ABSTRACT

A cutting tool, system, method and computer program product for increasing traceability of at least a first cutting edge of a cutting tool. The method includes detecting at least a first identification marker on the cutting tool, reading the at least first identification marker, decoding the at least first identification marker to determine at least a first cutting edge information data included in the machine readable code of the at least first identification marker, generating a first cutting tool identification data based on at least the at least first cutting edge information data, and storing at least any of the at least first cutting tool identification data and the at least first cutting edge information data in a memory.

### RELATED APPLICATION DATA

This application is a divisional of U.S. patent application Ser. No. 17/606,286 filed Oct. 25, 2021, which is a § 371 National Stage Application of PCT International Application No. PCT/EP2020/061622 filed Apr. 27, 2020.

### TECHNICAL FIELD

The disclosure pertains to the field of chip removing machining.

### BACKGROUND

A cutting tool may have one or more cutting edges that are used for removing chips from a piece of material. Typically a cutting tool is inserted into a cutting tool holder and a machine is e.g. rotating the cutting tool holder together with the cutting tool for processing the piece of material. The piece of material is processed when a cutting edge of the cutting tool comes in contact with the piece of material.

A cutting tool may have one or more cutting edges that are used for removing chips from the piece of material that is being processed by the cutting tool. A cutting edge becomes worn when it is removing chips form the piece of the material. When a cutting edge, or a plurality of cutting edges, of a cutting tool is worn to a certain extent, the cutting tool may need to be replaced or cannot be used for certain type of processing. Dependent on the usage of the cutting tool, e.g. dependent on the piece of material that is processed, and how the piece of material is processed, the cutting edges of the cutting tool becomes worn in a certain way. Today many end-customers are not managing how a certain cutting tool is used. Further, manufacturers of cutting tools and cutting edges are also not aware of e.g., certain usages that cause a certain worn of a certain cutting edge of a cutting tool. A manufacturer of a cutting tool also may have difficulties knowing when a certain cutting edge of a cutting tool was produced and under what circumstances the cutting edge was produced, the specific materials used etc.

### SUMMARY

Today there are cutting tools with an identification marking on each tool in order to manage the tools. A cutting tool can then be identified. There is, however, a demand for an easier way to increase traceability of the cutting edges on the cutting tools.

Different cutting edges can be worn differently, and a certain cutting edge may be dysfunctional on a certain cutting tool. Not knowing anything about the specific cutting edge but only the identification of the cutting tool will not help traceability of a particular cutting edge. In order to improve the manufacturing process of cutting edges, there is a demand for an increased traceability of each and every cutting edge, and traceability of the cutting tool with the certain cutting edges. There is also a demand for associating data such as operational data together with a specific cutting edge. Both manufacturers of cutting edges and end-customers of the cutting edges benefit from understanding production details and operation details that are associated with each cutting edge throughout the lifetime of each cutting edge of a cutting tool. These details can e.g. help the manufacturer to improve the manufacturing of cutting edges, and the details can help an end-customer of a cutting tool with cutting edges to manage the cutting tool and associate certain operation data with a certain cutting tool with certain cutting edges.

An aspect of the present disclosure is to provide a cutting tool, a system, a method and a computer program product, which seek to mitigate, alleviate, or eliminate one or more of the above-identified deficiencies in the art and disadvantages singly or in any combination.

The disclosure proposes a cutting tool comprising at least a first cutting edge and at least a first identification marker arranged at the first cutting edge, wherein the at least first identification marker is a machine readable code associated with a first cutting edge information data wherein the first cutting edge information data is a unique identity. This means that the at least a first cutting edge can be identified using the first cutting edge information data.

According to an aspect the cutting tool further comprises a second cutting edge and a second identification marker arranged at the second cutting edge wherein the second identification marker is a machine readable code associated with a second cutting edge information data. This means that the first cutting edge can be identified using the first cutting edge information data and that the second cutting edge can be identified using the second cutting edge information data.

According to an aspect, the first identification marker is arranged on the cutting tool at a distance to the first cutting edge that is shorter than the distance from the first identification marker to the second cutting edge, and the second identification marker is arranged on the cutting tool at a distance to the second cutting edge that is shorter than the distance from the second identification marker to the first cutting edge. One advantage with this arrangement of the identification markers is hence that an operator, or a machine, can determine which cutting edge that is associated with a certain identification marker.

According to an aspect, the at least first identification marker is at least any of, or a combination of at least any of, a two dimensional code, a three dimensional code, an image, a Quick Response code, a High Capacity Colored Two Dimensional Code, a European Article Number code, a DataMatrix code or a MaxiCode. This means that the at least first identification marker is visually readable on the cutting tool by a machine but also visually detectable by e.g. an operator handling the cutting tool.

The disclosure further proposes a system for increasing traceability of at least a first cutting edge of a cutting tool. The system includes a reader device for reading a machine readable code and an electronic device configured to be connected with the reader device. The electronic device has at least one processing circuitry configured to cause the system to detect, by the reader device, at least a first identification marker on the cutting tool. The at least first identification marker is a machine readable code read by the reader device, which decodes the at least first identification marker to determine at least first cutting edge information data included in the machine readable code of the at least first identification marker, wherein the first cutting edge information data is a unique identity.

The processing circuitry is then further configured to cause the system to generate a first cutting tool identification data based on at least the at least first cutting edge information data and store at least any of the at least first cutting tool identification data and the at least first cutting edge information data in a memory. One advantage with the system is that the generated first cutting tool identification data is based on the at least first cutting edge information data. This means that there is an association between the generated first cutting tool identification data and the at least first cutting edge information data.

According to an aspect the processing circuitry is further configured to cause the system to detect, by the reader device, a second identification marker on the cutting tool, wherein the second identification marker is a machine readable code read by the reader device, the first identification marker and the second identification marker, and decode the second identification marker to determine a second cutting edge information data included in the machine readable code of the second identification marker.

The processing circuitry is then further configured to cause the system to generate a first cutting tool identification data based on the first cutting edge information data and the second cutting edge information data. One advantage with the system is then that the generated first cutting tool identification data is based on the at least first cutting edge information data and the second cutting edge information data. This means that there is an association between the generated first cutting tool identification data and the at least first cutting edge information data and the second cutting edge information data.

According to an aspect the system further includes a cutting tool having at least a first cutting edge, wherein the cutting tool is configured to be mounted in a cutting tool holder. This means that the cutting tool can be mounted in a cutting tool holder of a machine for processing a piece of material. According to an aspect the cutting tool further includes a tool holder.

The disclosure further proposes a method for increasing traceability of at least a first cutting edge of a cutting tool. The method includes detecting, by a reader device, at least a first identification marker on the cutting tool, wherein the at least first identification marker is a machine readable code, reading, by the reader device, the at least first identification marker and decoding the read at least first identification marker to determine at least a first cutting edge information data included in the machine readable code of the at least first identification marker, wherein the first cutting edge information data is a unique identity.

The method then further comprises generating a first cutting tool identification data based on at least the at least first cutting edge information data, and storing at least any of the at least first cutting tool identification data and the at least first cutting edge information data in a memory. One advantage with the method is that the generated first cutting tool identification data is based on the at least first cutting edge information data. This means that there is an association between the generated first cutting tool identification data and the at least first cutting edge information data.

According to an aspect the method further includes the step of detecting, by the reader device, a second identification marker on the cutting tool wherein the second identification marker is a machine readable code, followed by the step of reading, by the reader device, the second identification marker, followed by the step of decoding the second identification marker to determine a second cutting edge information data comprised in the machine readable code of the second identification marker. The method then further includes the step of generating a first cutting tool identification data based on the first cutting edge information data and the second cutting edge information data.

According to an aspect the method further includes the step of receiving input of at least a first operation data to be associated with at least any of the at least first cutting tool identification data and the at least first cutting edge information data and the step of storing the at least first operation data associated with at least one of the at least first cutting tool identification data and the at least first cutting edge information data in the memory. This means that a first operation data can be stored and associated with at least one of the at least first cutting tool identification data and the at least first cutting edge information data, so that the first operation data can be retrieved at a later point of time with knowledge of at least one of the at least first cutting tool identification data and the at least first cutting edge information data.

According to an aspect the method further includes the step of generating at least a first association data including the at least first cutting tool identification data associated with at least one of the at least first cutting edge information data and the at least first operation data and storing the at least a first association data in the memory. This means that the at least a first association data can be used for identifying the at least first cutting tool identification data with knowledge of any of the at least first cutting edge information data and the at least first operation data, or that the at least a first association data can be used for identifying at least any of the first cutting edge information data and the at least first operation data with knowledge of the at least first cutting tool identification data.

According to an aspect the method further includes the step of detecting, by the reader device, at least the first identification marker on the cutting tool, followed by the step of reading, by the reader device, the at least first identification marker, and the step of decoding the at least first identification marker to determine the first cutting edge information data included in the machine readable code of the at least first identification marker.

The method then further includes the step of retrieving, from the memory, at least any of the first cutting tool identification data associated with the first cutting edge information data, and the at least first operation data associated with the first cutting edge information data. In other words by reading the at least the first identification marker with a reader device, information about any of the at least first cutting tool identification data and the at least first operation data can be retrieved from the memory.

According to an aspect the method further includes the step of displaying, via a user interface, at least any of the first cutting tool identification data, the first cutting edge information data, and the at least first operation data. This means that an operator can see the retrieved information via a user interface.

According to an aspect the method is performed at an electronic device having at least one processing circuitry.

The disclosure further proposes a computer program product comprising a non-transitory computer readable medium, having thereon a computer program comprising program instructions, the computer program being loadable into a processing circuitry and configured to cause execution of the method, and any aspect of the method, when the computer program is run by the processing circuitry.

The foregoing summary, as well as the following detailed description of the embodiments, will be better understood when read in conjunction with the appended drawings. It should be understood that the embodiments depicted are not limited to the precise arrangements and instrumentalities shown.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIGS. 1a-1d illustrates different cutting tools according to some aspects of the disclosure.

FIGS. 2a-2c illustrates different systems according to some aspects of the disclosure.

FIG. 3 illustrates a flow chart of the method steps according to some aspects of the disclosure.

FIG. 4 illustrates a computer program product according to some aspects of the disclosure.

FIG. 5 illustrates an example cutting tool identification data associated with cutting edge information data and operation data according to some aspects of the disclosure.

FIG. 6 illustrates example cutting tools each with unique cutting edge information data according to some aspects of the disclosure.

### DETAILED DESCRIPTION

Aspects of the present disclosure will be described more fully hereinafter with reference to the accompanying drawings. The method and device disclosed herein can, however, be realized in many different forms and should not be construed as being limited to the aspects set forth herein. Like numbers in the drawings refer to like elements throughout.

The terminology used herein is for the purpose of describing particular aspects of the disclosure only, and is not intended to limit the disclosure. As used herein, the singular forms “a”, “an” and “the” are intended to include the plural forms as well, unless the context clearly indicates otherwise.

In some implementations and according to some aspects of the disclosure, the functions or steps noted in the blocks can occur out of the order noted in the operational illustrations. For example, two blocks shown in succession can in fact be executed substantially concurrently or the blocks can sometimes be executed in the reverse order, depending upon the functionality/acts involved.

In the drawings and specification, there have been disclosed exemplary aspects of the disclosure. However, many variations and modifications can be made to these aspects without substantially departing from the principles of the present disclosure. Thus, the disclosure should be regarded as illustrative rather than restrictive, and not as being limited to the particular aspects discussed above. Accordingly, although specific terms are employed, they are used in a generic and descriptive sense only and not for purposes of limitation.

It should be noted that the word “comprising” does not necessarily exclude the presence of other elements or steps than those listed and the words “a” or “an” preceding an element do not exclude the presence of a plurality of such elements. It should further be noted that any reference signs do not limit the scope of the claims, that the example embodiments may be implemented at least in part by means of both hardware and software, and that several “means”, “units” or “devices” may be represented by the same item of hardware.

In order to e.g. improve the manufacturing process of cutting edges, there is a demand for an increased traceability of each and every cutting edge, and traceability of the cutting tool with the certain cutting edges. There is also a demand for associating data such as operational data together with a specific cutting edge. Both manufacturers of cutting tools and end-customers of the cutting tools benefit from understanding production details and operation details that are associated with each cutting edge throughout the lifetime of the cutting edge. These details can e.g. help the manufacturer to improve the manufacturing of cutting edges, and the details can help an end-customer of a cutting tool with cutting edges to e.g. manage the cutting tool and associate certain operation data with a certain cutting tool with certain cutting edges.

An object of the present disclosure is to provide a cutting tool, a system, a method and a computer program product which seek to mitigate, alleviate, or eliminate one or more of the above-identified deficiencies in the art and disadvantages singly or in any combination.

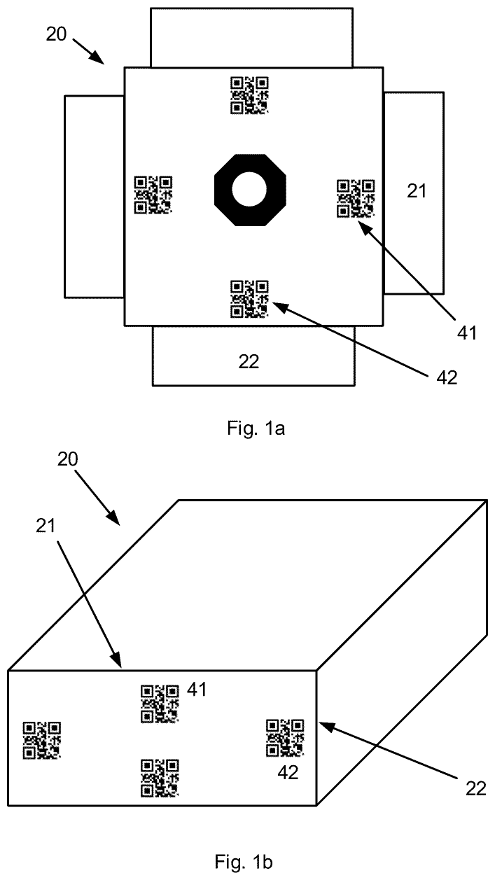

The disclosure proposes a cutting tool 20 including at least a first cutting edge 21 and at least a first identification marker 41 arranged at the first cutting edge 21. FIGS. 1a-1d illustrate different cutting tools according to some aspects of the disclosure. There are different kinds of cutting tools. Examples of cutting tools are cutting inserts, milling cutters, solid end mills, turning tools, drilling tools, boring heads, reaming tools, thread turning tools, thread milling tools, and thread tapping tools, etc.

The at least first identification marker 41 is a machine readable code associated with a first cutting edge information data 1ceID. This means that the at least a first cutting edge 21 can be identified using the first cutting edge information data 1ceID. According to an aspect the cutting edge information data is a unique identity. According to an aspect the cutting edge information data is a number and/or a combination of figures and letters. According to an aspect the cutting edge information data is a serial number. Dependent on at what point in the product lifetime the cutting tool 20 is, the cutting edge information data may comprise further information as will be discussed in more detail below.

The cutting tool 20 illustrated in FIG. 1d has a first cutting edge 21 and a first identification marker 41 arranged at the first cutting edge 21. According to an aspect the cutting tool 20 includes a plurality of cutting edges, as illustrated in FIGS. 1a-1c.

According to an aspect, the cutting tool 20 further includes a second cutting edge 22 and a second identification marker 42 arranged at the second cutting edge 22, wherein the second identification marker 42 is a machine readable code associated with second cutting edge information data 2ceID. This means that the first cutting edge 21 can be identified using the first cutting edge information data 1ceID and that the second cutting edge 22 can be identified using the second cutting edge information data 2ceID. In other words the different cutting edges have different identification markers and each cutting edge can be associated with individual cutting edge information data.

According to an aspect, the first identification marker 41 is arranged on the cutting tool 20 at a distance to the first cutting edge 21 that is shorter than the distance from the first identification marker 41 to the second cutting edge 22, and the second identification marker 42 is arranged on the cutting tool 20 at a distance to the second cutting edge 22 that is shorter than the distance from the second identification marker 42 to the first cutting edge 21. This is illustrated in the FIGS. 1a-1c. One advantage with this arrangement of the identification markers is that an operator, or a machine, can determine which cutting edge that is associated with a certain identification marker. An operator can easy determine that a certain identification marker is associated with a certain cutting edge by visual inspection of the cutting tool. A machine, e.g. utilizing a camera sensor an image processing, can also determine that a certain identification marker is associated with a certain cutting edge by e.g. using object recognition to determine the distance to the cutting edge.

According to an aspect, the at least first identification marker 41 is at least any of, or a combination of at least any of, a two dimensional code, a three dimensional code, an image, a Quick Response code, a High Capacity Colored Two Dimensional Code, a European Article Number code, a DataMatrix code or a MaxiCode. This means that the at least first identification marker 41 is visually readable on the cutting tool 20 by a machine but also visually detectable by e.g. an operator handling the cutting tool.

According to an aspect the at least first identification marker 41 is an industry standard machine readable code. According to an aspect the at least first identification marker 41 is a company internal machine readable code. According to an aspect the at least first identification marker 41 is an open source machine readable code.

According to an aspect, the at least first identification marker 41 is applied using different colours. According to an aspect, the at least first identification marker 41 is etched at the cutting tool close to the cutting edge or etched on the surface of the cutting edge.

According to an aspect, the association between the machine readable code and the cutting edge information data is defined by a known algorithm for the specific identification marker. According to an aspect, cutting edge information data is coded, using a known algorithm for a specific identification marker, which determines the appearance of the identification marker.

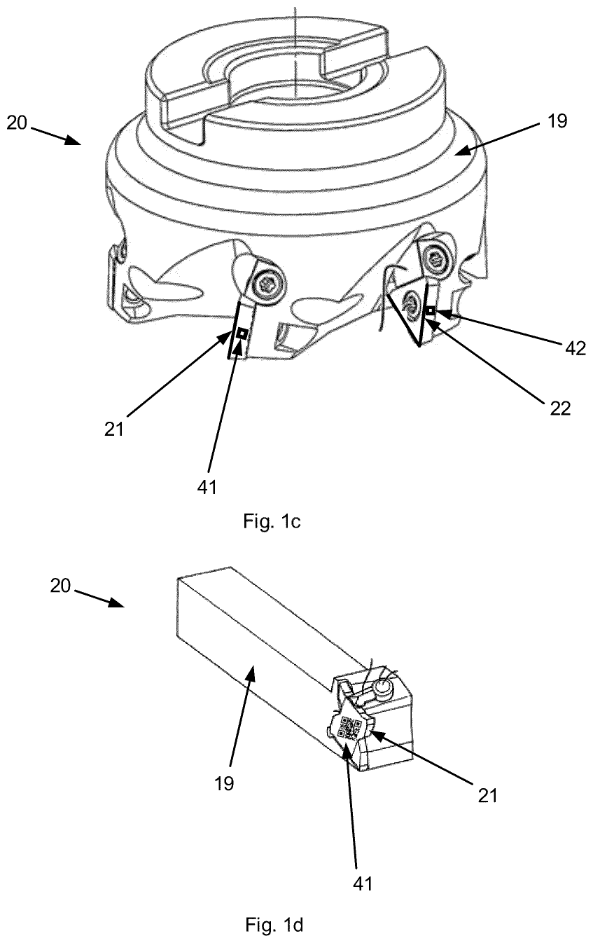

The disclosure further proposes a system 100 for increasing traceability of at least a first cutting edge 21 of a cutting tool 20. FIGS. 2a-2c illustrates different systems according to some aspects of the disclosure.

The system 100 includes a reader device 10a, 10b, 10c for reading a machine readable code. According to an aspect, the reader device 10a, 10b, 10c is any of a camera based reader; a video camera reader; a pen-type reader with photodiodes; a laser scanner; a charge-coupled device, CCD, reader or a cell phone camera.

The reader device 10a, 10b, 10c may be a component integrated in an electronic device 1a,1b, 1c or a stand-alone component. The system further includes an electronic device 1a, 1b, 1c configured to be connected with the reader device 10a, 10b, 10c. According to an aspect, the electronic device 1a, 1b, 1c is configured to be connected with a communication network 50.

FIG. 2a illustrates an electronic device 1a in form of a smartphone, tablet, cellular phone, feature phone or any portable electronic device. In one example, illustrated in FIG. 2a, the reader device 10a is the camera of a smartphone 1a.

The electronic device may also be an installed electronic device 1b, e.g. a part of a machine as illustrated in FIG. 2b. In one example, illustrated in FIG. 2b, the reader device 10b is a stand-alone reader device connected to the electronic device 1b and installed as a part of the machine. According to an aspect the electronic device is a remote server 1c connected to a reader device 10c via a communication network 50.

According to an aspect, the electronic device 1a, 1b, 1c further includes a memory 103a, 103b, 103c. According to an aspect one electronic device 1a, 1b, 1c is configured to be connected to another electronic device 1a, 1b, 1c via a communication network 50. In one example the communication network 50, as illustrated in e.g. FIG. 2a and FIG. 2c, is a standardized wireless local area network such as a Wireless Local Area Network, WLAN, Bluetooth™, ZigBee, Ultra-Wideband, Near Field Communication, NFC, Radio Frequency Identification, RFID, or similar network. In one example the communication network 50 is a standardized wireless wide area network such as a Global System for Mobile Communications, GSM, Extended GSM, General Packet Radio Service, GPRS, Enhanced Data Rates for GSM Evolution, EDGE, Wideband Code Division Multiple Access, WCDMA, Long Term Evolution, LTE, Narrowband-IoT, 5G, Worldwide Interoperability for Microwave Access, WiMAX or Ultra Mobile Broadband, UMB or similar network. The communication network 50 can also be a combination of both a local area network and a wide area network. The communication network 50 can also be a wired network. According to an aspect the communication network 50 is defined by common Internet Protocols. According to an aspect the electronic device 1a, 1b, 1c is configured to be connected to a memory 103a, 103b, 103c in another electronic device 1a, 1b, 1c via the communication network 50.

The electronic device 1a, 1b, 1c has at least one processing circuitry 102a, 102b, 102c configured to cause the system 100 to detect, by the reader device 10a, 10b, 10c, at least a first identification marker 41 on the cutting tool 20 wherein the at least first identification marker 41 is a machine readable code. The processing circuitry 102a, 102b, 102c is then further configured to cause the system 100 to read, by the reader device 10a, 10b, 10c, the at least first identification marker 41 and decode the at least first identification marker 41 to determine at least a first cutting edge information data 1ceID included in the machine readable code of the at least first identification marker 41.

The processing circuitry 102a, 102b, 102c is then further configured to cause the system 100 to generate a first cutting tool identification data 1ctID based on at least the at least first cutting edge information data 1ceID and store at least any of the at least first cutting tool identification data 1ctID and the at least first cutting edge information data 1ceID in a memory 103a, 103b, 103c. One advantage with the system is that the generated first cutting tool identification data 1ctID is based on the at least first cutting edge information data 1ceID. This means that there is an association between the generated first cutting tool identification data 1ctID and the at least first cutting edge information data 1ceID.

According to an aspect the first cutting tool identification data 1ctID is based on a unique identity comprised in the first cutting edge information data 1ceID. In one example the first cutting edge information data 1ceID is a serial number, e.g. ABCD12345, and the first cutting tool identification data 1ctID is generated based on the serial number, e.g. by adding the actual time, e.g. 2019/4/15 15:36, when the first cutting tool identification data 1ctID is generated, e.g. “2019/4/15 15:36 ABCD12345.”

In another example, the first cutting edge information data 1ceID is a serial number, e.g. ABCD12345, and the first cutting tool identification data 1ctID is generated based on the serial number, e.g. by adding a customer order number, e.g. 12009800, when the first cutting tool identification data 1ctID is generated, e.g. “12009800 ABCD12345”. In other words from the moment when the first cutting tool identification data 1ctID is generated there is an association between the cutting tool identification data 1ctID and the at least first cutting edge information data 1ceID.

According to an aspect, the at least first cutting edge information data 1ceID includes a unique identity and manufacturing information data. In one example, the manufacturer of cutting tools generates cutting edge information data based on the unique identity, e.g. a serial number, and adding manufacturing data such as manufacturing date and time, material data, oven data, etc.

According to an aspect the processing circuitry 102a, 102b, 102c is further configured to cause the system 100 to detect, by the reader device 10a, 10b, 10c, a second identification marker 42 on the cutting tool 20 wherein the second identification marker 42 is a machine readable code. The processing circuitry 102a, 102b, 102c is then further configured to cause the system 100 to read, by the reader device 10a, 10b, 10c, the second identification marker 42, and decode the second identification marker 42 to determine a second cutting edge information data 2ceID comprised in the machine readable code of the second identification marker 42. The processing circuitry 102a, 102b, 102c is then further configured to cause the system 100 to generate a first cutting tool identification data 1ctID based on the first cutting edge information data 1ceID and the second cutting edge information data 2ceID. One advantage with the system is then that the generated first cutting tool identification data 1ctID is based on the at least first cutting edge information data 1ceID and the second cutting edge information data 2ceID. This means that there is an association between the generated first cutting tool identification data 1ctID and the at least first cutting edge information data 1ceID and the second cutting edge information data 2ceID.

According to an aspect the first cutting tool identification data 1ctID is based on the unique identity comprised in the first cutting edge information data 1ceID and on the unique identity comprised in the second cutting edge information data 2ceID. In one example, the first cutting edge information data 1ceID is a serial number, e.g. ABCD12345, and the second cutting edge information data 2ceID is a serial number, e.g. EFGH67890, and the first cutting tool identification data 1ctID is generated based on both serial numbers, e.g. by adding the actual time e.g. 2019/04/15 15:36 when the first cutting tool identification data 1ctID is generated, e.g. “2019/04/15 15 15:36 ABCD12345 EFGH67890.”

In another example, the first cutting edge information data 1ceID is a serial number, e.g. ABCD12345, and the second cutting edge information data 2ceID is a serial number, e.g. EFGH67890, and the first cutting tool identification data 1ctID is generated based on both serial numbers, e.g. by adding a customer order number, e.g. 12009800, when the first cutting tool identification data 1ctID is generated, e.g. “12009800 ABCD12345 EFGH67890”. In other words from the moment when the first cutting tool identification data 1ctID is generated there is an association between the cutting tool identification data 1ctID and the first cutting edge information data 1ceID and the second cutting edge information data 2ceID.

According to an aspect, when manufacturing the cutting tool 20, the manufacturer uses all the existing identification markers on each cutting edge that are mounted on the cutting tool 20, in order to generate a first cutting tool identification data 1ctID that is based on each existing cutting edge information data on the cutting tool 20. In other words, when generating the first cutting tool identification data 1ctID there is an association with each cutting edge information data of each cutting edge that exists on the cutting tool 20. This may be desired in order to be able to trace a certain cutting edge at a later point of time during the lifetime of the cutting tool 20.

According to an aspect, the system 100 further includes a cutting tool 20 having at least a first cutting edge 21, wherein the cutting tool 20 is configured to be mounted in a cutting tool holder 19. This means that the cutting tool can be mounted in a cutting tool holder 19 of a machine for processing a piece of material. According to an aspect the cutting tool 20 further includes a tool holder 19.

The disclosure further proposes a method for increasing traceability of at least a first cutting edge 21 of a cutting tool 20. According to an aspect, the described system 100 is configured to carry out any or more of the aspects of the method that will be described hereinafter.

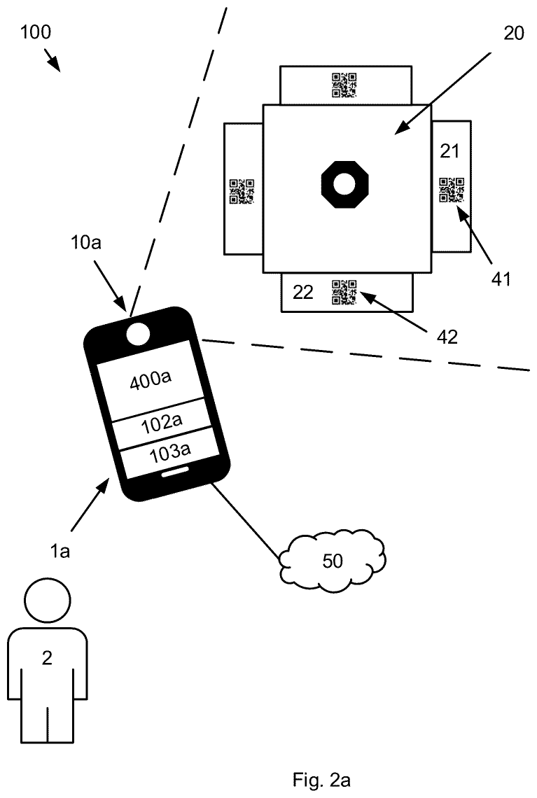

The steps of the method is illustrated in FIG. 3. The method includes the step of Sla detecting, by a reader device 10a, 10b, 10c, at least a first identification marker 41 on the cutting tool 20, wherein the at least first identification marker 41 is a machine readable code. The method further includes the step of S2a reading, by the reader device 10a, 10b, 10c, the at least first identification marker 41 and the step of S3a decoding the at least first identification marker 41 to determine at least a first cutting edge information data 1ceID included in the machine readable code of the at least first identification marker 41.

The method further includes the step of S4a generating a first cutting tool identification data 1ctID based on at least the at least first cutting edge information data 1ceID and the step of S7 storing at least any of the at least first cutting tool identification data 1ctID and the at least first cutting edge information data 1ceID in a memory 103a, 103b, 103c. One advantage with the method is that the generated first cutting tool identification data 1ctID is based on the at least first cutting edge information data 1ceID. This means that there is an association between the generated first cutting tool identification data 1ctID and the at least first cutting edge information data 1ceID.

According to an aspect the method further includes the step of S1b detecting, by the reader device 10a, 10b, 10c, a second identification marker 42 on the cutting tool 20 wherein the second identification marker 42 is a machine readable code; followed by the step of S2b reading, by the reader device 10a, 10b, 10c, the second identification marker 42, followed by the step of S3b decoding the second identification marker 41 to determine a second cutting edge information data 2ceID included in the machine readable code of the second identification marker 42.

The method then further includes the step of S4b generating a first cutting tool identification data 1ctID based on the first cutting edge information data 1ceID and the second cutting edge information data 2ceID. One advantage with this aspect of the method is that the generated first cutting tool identification data 1ctID is based on the at least first cutting edge information data 1ceID and the second cutting edge information data 2ceID. This means that there is an association between the generated first cutting tool identification data 1ctID and the at least first cutting edge information data 1ceID and the second cutting edge information data 2ceID.

According to an aspect the method further includes the step of S5 receiving input of at least a first operation data 1OD to be associated with at least any of the at least first cutting tool identification data 1ctID and the at least first cutting edge information data 1ceID and the step of S8 storing the at least first operation data 1OD associated with at least one of the at least first cutting tool identification data 1ctID and the at least first cutting edge information data 1ceID in the memory 103a, 103b, 103c. This means that a first operation data 1OD can be stored and associated with at least one of the at least first cutting tool identification data 1ctID and the at least first cutting edge information data 1ceID, so that the first operation data 1OD can be retrieved at a later point of time with knowledge of at least one of the at least first cutting tool identification data 1ctID and the at least first cutting edge information data 1ceID.

According to an aspect, the input of at least a first operation data 1OD is input by an operator via a user interface 400a, 400b, 400c of the electronic device 1a, 1b,1c. According to an aspect, the input of at least a first operation data 1OD is input from a machine connected to the electronic device 1a, 1b, 1c.

According to an aspect, the least a first operation data 1OD is “preparation for operation data.” In one example, the preparation for operation data relates to manufacturing data such as batch number data, manufacturing date and time data, material composition data, oven identification data, manufacturing plant data, material sourcing data, contact information data, part identification data, order identification data etc.

According to an aspect, the at least first operation data 1OD is “after operation data.” In one example, the after operation data relates to usage by a customer such as machine identification data, usage date and time data, material handling data, runtime data, temperature data, rounds per minute data, material identification data, operator identification data, machine identification data, customer identification data, free text data.

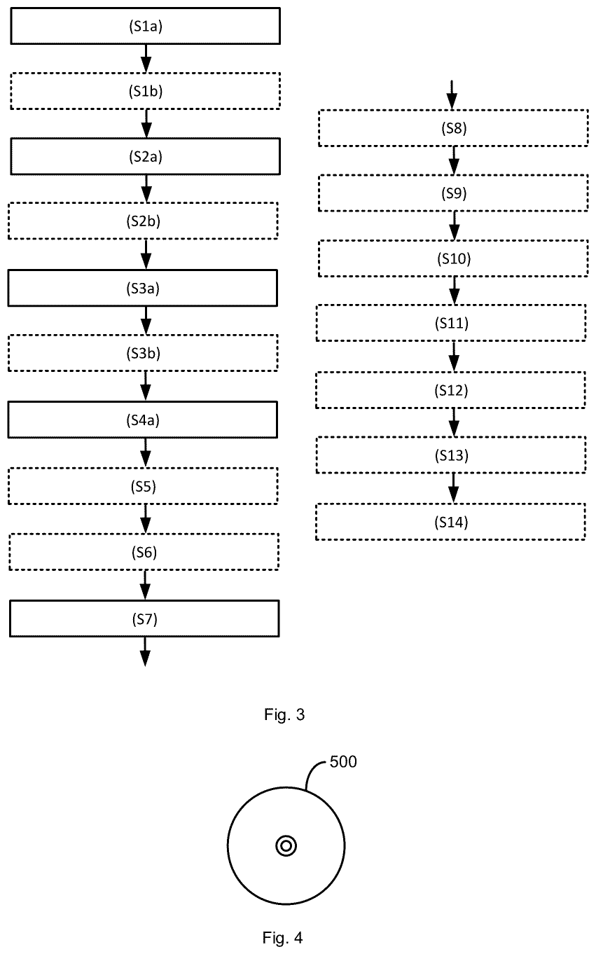

FIG. 5 illustrates example associations that can be determined out from a first cutting tool identification data 1ctID. In the example in FIG. 5 the first cutting tool identification data 1ctID is generated based on five different cutting edge information: 1ceID=AB01, 2ceID=AB02 3ceID=AB03, 4ceID=AB04 and 5ceID=AB05. In the example in FIG. 5 the first cutting tool identification data 1ctID is further associated with a first operation data 1OD=RT10h and a second operation data 2OD=RT35h.

According to an aspect, the method further includes the step of S6 of generating at least a first association data 1AD including the at least first cutting tool identification data 1ctID associated with at least one of the at least first cutting edge information data 1ceID and the at least first operation data 1OD and S9 storing the least a first association data 1AD in the memory 103a, 103b, 103c. This means that the at least a first association data 1AD can be used for identifying the at least first cutting tool identification data 1ctID with knowledge of any of the at least first cutting edge information data 1ceID and the at least first operation data 1OD, or that the at least a first association data 1AD can be used for identifying at least any of the first cutting edge information data 1ceID and the at least first operation data 1OD with knowledge of the at least first cutting tool identification data 1ctID. Again, FIG. 5 is used for illustrating a first association data 1AD. In the example in FIG. 5 the first association data 1AD comprising all associations possible between the plural cutting tool identification data; 1ctID, 2ctID, 3ctID, 4ctID and 5ctID, and the first cutting tool identification data 1ctID, and the first operation data 1OD=RT10h and the second operation data 2OD=RT35h.

According to an aspect, the method further includes the step S10 detecting, by the reader device 10a, 10b, 10c, at least the first identification marker 41 on the cutting tool 20, followed by the step of S11 of reading, by the reader device 10a, 10b, 10c, the at least first identification marker 41, and the step of S12 decoding the at least first identification marker 41 to determine the first cutting edge information data 1ceID included in the machine readable code of the at least first identification marker 41.

The method further includes the step of S13 retrieving, from the memory 103a, 103b, 103c, at least any of the first cutting tool identification data 1ctID associated with the first cutting edge information data 1ceID, and the at least first operation data 1OD associated with the first cutting edge information data 1ceID. In other words by reading the at least the first identification marker 41 with a reader device 10a, 10b, 10c information about any of the at first cutting tool identification data 1ctID and the at least first operation data 1OD can be retrieved from the memory 103a, 103b, 103c.

An example is illustrated with reference to FIG. 5. In the example the reader device 10a, 10b, 10c reads a second identification marker 42 to determine the second cutting edge information data 2ceID comprised in the machine readable code of the second identification marker 42. In the example in FIG. 5 the second cutting edge information data 2ceID=AB02. Now since “AB02” is associated with the first cutting tool identification data 1ctID, it can be determined that the read identification marker, in this case the second identification marker 42, belongs to the cutting tool 20 with the first cutting tool identification data 1ctID. Since the first cutting tool identification data 1ctID is further associated with four other cutting edge information data, it can be determined that the cutting tool 20 further comprises the four cutting edges associated with the cutting edge identification data 1ceID, 3ceID, 4ceID and 5ceID. In the example of FIG. 5 it can further be determined that the cutting tool 20 is also associated with a first operation data and a second operation data.

In other words, in a use case example, an operator may use a reader device 10a, 10b, 10c to read any identification marker to determine associated information such as the cutting tool identification data and operation data. In an example, by reading one identification marker at a cutting edge of a cutting tool with 24 different cutting edges, information about each of the other 23 cutting edges on the cutting tool can be retrieved, together with e.g. operation data associated with the cutting tool as such or associated with each and every cutting edge.

In particular this is possible when a manufacturer of a cutting tool generates the cutting tool identification data based on each and every cutting edge information data of each and every cutting edge of a specific cutting tool.

According to an aspect, the method further includes the step of S14 displaying, via a user interface 400a, 400b, 400c, least any of the first cutting tool identification data 1ctID, the first cutting edge information data 1ceID, and the at least first operation data 1OD. This means that an operator can see the retrieved information via a user interface 400a, 400b, 400c.

In particular, this is of interest for traceability of a cutting edge of a cutting tool. In one example a cutting tool has not processed a piece of material as expected and is malfunctioning. An operator may use a reader device to retrieve information about the particular cutting edge. Operational data such as preparation for operation data including material composition data, together with operation data such as after operation data including runtime data, may give the operator, or e.g. a manufacturer of a cutting tool, a certain understanding of why this cutting edge on this cutting tool has not performed as expected. It may turn out that the material composition when manufacturing the cutting edge was not intended to the total runtime that the cutting edge has been exposed to. A manufacturer could in this case e.g. recommend another cutting tool with other cutting edges for the particular machining, but also learn what will happen to a cutting edge of certain material composition when being exposed to a certain runtime.

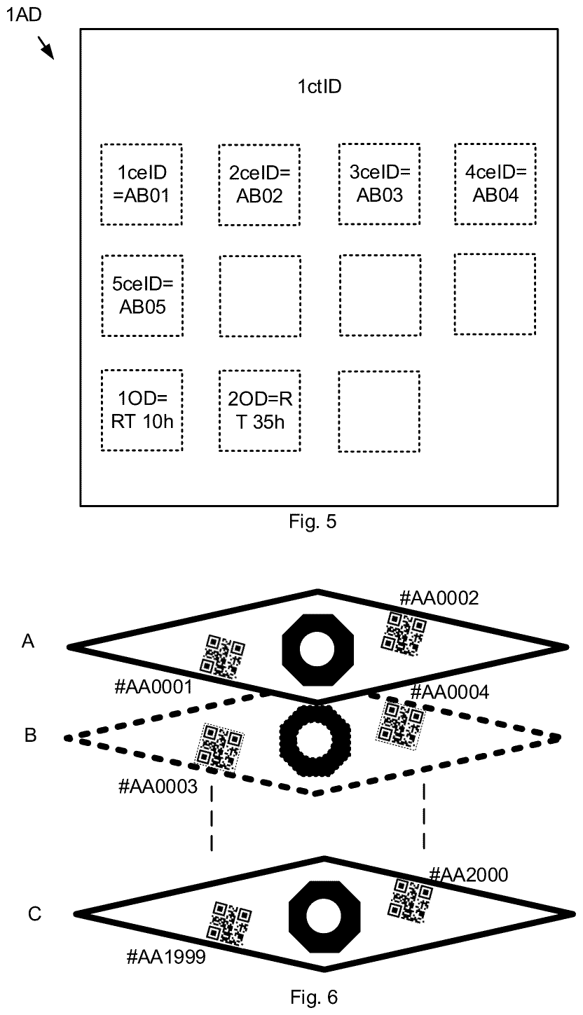

FIG. 6 illustrates example cutting tools each with unique cutting edge information data according to some aspects of the disclosure. According to an aspect, when manufacturing cutting tools the cutting tool identification data is not yet generated but each cutting tool is provided with identification markers that are machine readable codes associated with cutting edge information data. This means that each cutting edge can be identified using the cutting edge information data. According to an aspect the cutting edge information data is a unique identity.

In the example illustrated in FIG. 6 a batch of 1000 cutting tools are manufactured. The first cutting tool, A, is provided with two identification markers, each associated with cutting edge information data that is unique, in the example #AA0001 and #AA0002. The second cutting tool, B, is provided with two identification markers, each associated with cutting edge information data that is unique, in the example #AA0003 and #AA0004. The last cutting tool of the batch, C, is also provided with two identification markers, each associated with cutting edge information data that is unique, in the example #AA1999 and #AA2000.

According to an aspect, the method is performed at an electronic device 1a, 1b, 1c having at least one processing circuitry 102a, 102b, 102c.

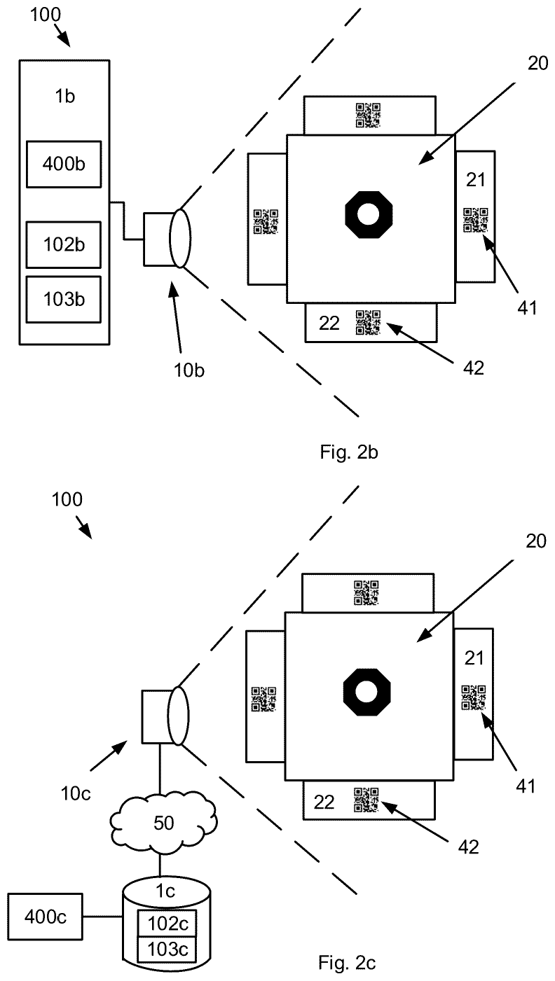

The disclosure further proposes, as illustrated in FIG. 4, a computer program product 500 comprising a non-transitory computer readable medium, having thereon a computer program comprising program instructions, the computer program being loadable into a processing circuitry 102a, 102b, 102c and configured to cause execution of the method, and any aspect of the method, when the computer program is run by the processing circuitry 102a, 102b, 102c.

According to an aspect, the system 100 is configured to carry out any or more of the aspects of the described method. According to an aspect of the disclosure, the method is carried out by instructions in a software program that is downloaded and run in the system 100.

Although the present embodiment(s) has been described in relation to particular aspects thereof, many other variations and modifications and other uses will become apparent to those skilled in the art. It is preferred therefore, that the present embodiment(s) be limited not by the specific disclosure herein, but only by the appended claims.

What is claimed is:

1. A system for increasing traceability of at least a first cutting edge of a cutting tool, the system comprising:
a reader device for reading a machine readable code;
an electronic device configured to be connected with the reader device, the electronic device having at least one processing circuitry configured to cause the system to:
detect, by the reader device, at least a first identification marker on the cutting tool wherein the at least first identification marker is a machine readable code;
read, by the reader device, the at least first identification marker;
decode the at least first identification marker to determine at least a first cutting edge information data comprised in the machine readable code of the at least first identification marker, wherein the first cutting edge information data is a unique identity;
generate a first cutting tool identification data based on at least the at least first cutting edge information data; and
store at least any of the at least first cutting tool identification data and the at least first cutting edge information data in a memory.

2. The system according to claim 1, wherein the processing circuitry is further configured to cause the system to detect, by the reader device, a second identification marker on the cutting tool wherein the second identification marker is a machine readable code read, by the reader device, the second identification marker decode the second identification marker to determine a second cutting edge information data comprised in the machine readable code of the second identification marker, and generate a first cutting tool identification data based on the first cutting edge information data and the second cutting edge information data.

3. The system according claim 1, further comprising a cutting tool including at least a first cutting edge, wherein the cutting tool is configured to be mounted in a cutting tool holder.

4. A method for increasing traceability of at least a first cutting edge of a cutting tool, the method comprising:
detecting, by a reader device, at least a first identification marker on the cutting tool, wherein the at least first identification marker is a machine readable code;
reading, by the reader device, the at least first identification marker;
decoding the at least first identification marker to determine at least a first cutting edge information data comprised in the machine readable code of the at least first identification marker, wherein the first cutting edge information data is a unique identity;
generating a first cutting tool identification data based on at least the at least first cutting edge information data; and
storing at least any of the at least first cutting tool identification data and the at least first cutting edge information data in a memory.

5. The method according to claim 4, further comprising detecting, by the reader device, a second identification marker on the cutting tool wherein the second identification marker is a machine readable code, reading, by the reader device, the second identification marker, decoding the second identification marker to determine a second cutting edge information data comprised in the machine readable code of the second identification marker, and generating a first cutting tool identification data based on the first cutting edge information data and the second cutting edge information data.

6. The method according to claim 4, further comprising receiving input of at least a first operation data to be associated with at least any of the at least first cutting tool identification data and the at least first cutting edge information data, and storing the at least first operation data associated with at least one of the at least first cutting tool identification data and the at least first cutting edge information data in the memory.

7. The method according to claim 6, further comprising generating at least a first association data comprising the at least first cutting tool identification data associated with at least one of the at least first cutting edge information data and the at least first operation data, and storing the least a first association data in the memory.

8. The method according to claim 6, further comprising detecting, by the reader device, at least the first identification marker on the cutting tool reading, by the reader device, the at least first identification marker decoding the at least first identification marker to determine the first cutting edge information data comprised in the machine readable code of the at least first identification marker and retrieving, from the memory, at least any of the first cutting tool identification data associated with the first cutting edge information data and the at least first operation data associated with the first cutting edge information data.

9. The method according to claim 6, further comprising displaying, via a user interface, at least any of the first cutting tool identification data, the first cutting edge information data, and the at least first operation data.

10. The method according to claim 4, wherein the method is performed by an electronic device having at least one processing circuitry.

11. A computer program product including a non-transitory computer readable medium, having thereon a computer program including program instructions, the computer program being loadable into a processing circuitry and configured to cause execution of the method according to claim 4 when the computer program is run by the processing circuitry.
